(19) United States
(12) Patent Application Publication
(10) Pub. No.: US 2026/0050568 A1
(43) Pub. Date: Feb. 19, 2026

(54) INTEGRATED MULTI-PORT IO-LINK MASTER TRANSCEIVER AND ADAPTIVE DIO DESIGN

(71) Applicant: STMicroelectronics International N.V., Geneva (CH)

(72) Inventors: Guozhu FENG, Shenzhen, Guangdong (CN); Allan Rio Valentos LAGASCA, Paranaque, Metro Manila (PH)

(73) Assignee: STMicroelectronics International N.V., Geneva (CH)

(21) Appl. No.: 19/293,292

(22) Filed: Aug. 7, 2025

(30) Foreign Application Priority Data
Aug. 14, 2024 (CN) 202411121338.2

(51) Int. Cl. G06F 13/42

(52) U.S. Cl. CPC G06F 13/4282; G06F 2213/0012

(57) ABSTRACT

Disclosed herein is a system, including a microcontroller unit (MCU) and a plurality of reconfigurable devices connected to the MCU in a daisy chain arrangement via a Serial Peripheral Interface (SPI) protocol. Each reconfigurable device includes control circuitry configured for operating in both a Digital Input/Output (DIO) mode and an IO-Link mode, a digital logic for switching the DIO control circuitry between the DIO mode and the IO-Link mode, output drivers connected between outputs of the control circuitry and respective output pins of a plurality of pin sets, input filters connected between inputs of the control circuitry and respective inputs pins of the plurality of pin sets, and an SPI interface for communication with the MCU and other reconfigurable devices in the daisy chain, with the digital control facilitating communication between the SPI interface and the control circuitry.

### PRIORITY CLAIM

This application claims the priority benefit of Chinese Application for U.S. Pat. No. 20,241,1121338.2, filed on Aug. 14, 2024, the content of which is hereby incorporated by reference in its entirety to the maximum extent allowable by law.

### TECHNICAL FIELD

This disclosure relates generally to industrial automation and control systems, and more particularly to a reconfigurable integrated circuit system that combines IO-Link master functionality with digital input/output (DIO) capabilities.

### BACKGROUND

IO-Link is a standardized, serial, point-to-point communication protocol used in industrial automation for connecting sensors and actuators to a controller. IO-Link master devices serve as the interface between the IO-Link devices (sensors and actuators) and the higher-level fieldbus or industrial Ethernet network. They manage the communication with the connected IO-Link devices, enabling data exchange, parameterization, and diagnostics.

Current IO-Link master devices require additional components to support an 8-port master transceiver along with external drivers. They lack flexibility to support digital input/output (DIO) functionality. Existing solutions need 8 separate transceiver chips to enable 8-port output, which increases the number of external parts required to support each device and results in numerous interfaces to each individual device.

As such, further development is needed.

### SUMMARY

A system disclosed herein includes a microcontroller unit (MCU) and multiple reconfigurable devices connected to the MCU in a daisy chain arrangement via a Serial Peripheral Interface (SPI) protocol. Each reconfigurable device has digital Input/Output (DIO) control circuitry for operating in both a Digital Input/Output (DIO) mode and an IO-Link mode, input/output link (IO-Link) logic circuitry for providing data to and reading data from the DIO control circuitry when in IO-Link mode, digital logic for switching between modes, output drivers connected between DIO control circuitry outputs and output pins of pin sets, input filters connected between DIO control circuitry inputs and input pins of the pin sets, and an SPI interface for communication with the MCU and other devices. The digital logic facilitates communication between the SPI interface and both the DIO control circuitry and IO-Link logic circuitry.

Each pin set may have a power supply pin (L+), a communication/qualified input pin (C/Qi), a communication/qualified output pin (C/Qo), and an additional input/output pin (I/Q).

In IO-Link mode, each pin set may be configured as an IO-Link channel.

In DIO mode, the C/Qi and I/Q pins may be configured as digital input channels, while the L+ and C/Qo pins may be configured as digital output channels.

The digital output channels may be configurable as all high-side outputs.

Alternatively, the digital output channels may be configurable as a combination of high-side and low-side outputs.

The SPI interface of each reconfigurable device may have a Serial Data In (SDI) pin, a Serial Data Out (SDO) pin, a Chip Select (CS) pin, and a Clock (CLK) pin.

The MCU MOSI pin may connect to the first device SDI pin, its CS pin to all devices CS pins, and its CLK pin to all devices CLK pins. Each device SDO pin may connect to the next device SDI pin, with the last device SDO pin connected to the MCU MISO pin.

Each reconfigurable device in the daisy chain arrangement may be individually addressable and configurable by the MCU through the SPI interface.

Also disclosed herein is a method of operating the system that includes configuring each device mode, providing data between IO-Link logic and DIO control circuitry in IO-Link mode, controlling digital I/O in DIO mode, switching modes, driving outputs, filtering inputs, and facilitating communication via the SPI interface.

The method may include configuring each pin set with L+, C/Qi, C/Qo, and I/Q pins. In IO-Link mode, each pin set may be configured as an IO-Link channel. In DIO mode, C/Qi and I/Q pins may be configured as digital inputs, while L+ and C/Qo pins may be configured as digital outputs. The digital output channels may be configured as all high-side outputs or as a combination of high-side and low-side outputs. The SPI interface may be configured with SDI, SDO, CS, and CLK pins.

The method may include connecting the MCU MOSI pin to the first device SDI pin, the MCU CS and CLK pins to all devices respective pins, and each device SDO pin to the next device SDI pin, with the last device SDO pin connected to the MCU MISO pin.

The method may include individually addressing and configuring each device in the daisy chain arrangement through the SPI interface.

### BRIEF DESCRIPTION OF THE DRAWINGS

FIG. 1 is a block diagram of system disclosed herein including daisy-chained reconfigurable DIO/IO-Link devices.

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

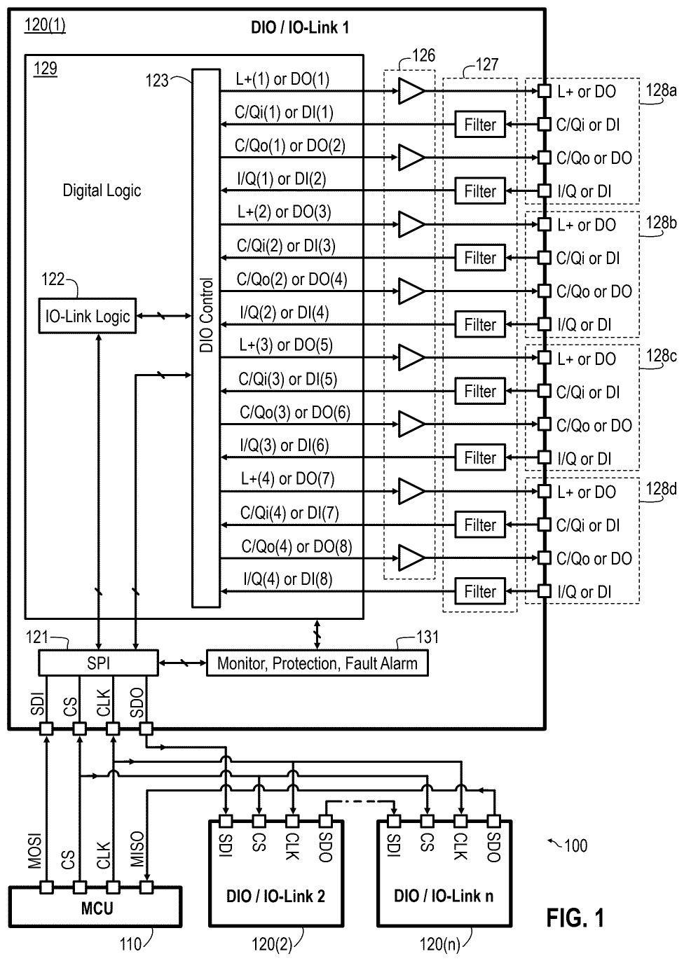

Disclosed herein is an integrated chip solution for industrial Internet of Things (IIoT) and automation systems. To that end, shown in FIG. 1 is a system 100 including a Microcontroller Unit (MCU) 110 connected to multiple reconfigurable Digital Input/Output (DIO)/IO-Link devices 120(1) to 120(n) via a Serial Peripheral Interface (SPI) protocol in a daisy chain arrangement, where n represents the total number of devices in the system.

The MCU 110 includes a master-out, sub-in (MOSI) pin, a chip select pin (CS), a clock pin (CLK) and a master-in, sub-out (MISO) pin.

Each DIO/IO-Link device, for example device 120(1), is an integrated circuit capable of operating in either DIO mode or IO-Link mode. The device 120(1) includes a digital logic block 129 that contains DIO Control 123 operable in both IO-Link mode and DIO mode, and an IO-Link logic block 122. The digital logic block 129 manages the switching between DIO and IO-Link modes, while the SPI interface 121 manages communication with others of the devices 120(1), . . . , 120(n) in the daisy chain.

The SPI interface 121 is connected via data connections to both the DIO Control 123 and the IO-Link logic 122 within the digital logic block 129. Additionally, there is a data connection between the IO-Link logic 122 and the DIO Control 123, allowing for seamless coordination between the two modes of operation.

The DIO Control 123 is connected to four sets of pins 128a, . . . , 128d through output drivers 126 and input filters 127. Pins of the sets of pins 128a, . . . , 128d used as inputs provide their inputs to the DIO Control 123 through input filters 127, and pins of the sets of pins 128a, . . . , 128d receive their output signals from the DIO Control 123 through output drivers 126.

While the device 120(1) is described with four sets of pins 128a, . . . , 128d, it should be understood that the design is scalable and can accommodate any number of pin sets as required by the application. For instance, the device could be expanded to include additional sets such as 128e, 128f, and so on, each providing an additional set of configurable I/O pins. This scalability allows for greater flexibility in system design, enabling the device to be adapted for applications requiring a higher number of I/O channels without fundamentally altering its architecture. The DIO Control 123 and IO-Link logic 122 would then manage and configure these additional pin sets in the same manner as the four sets described, maintaining the device's ability to switch between DIO and IO-Link modes across all available pin sets. This applies to each such device 120(1), . . . , 120(n).

When a device 120(1), . . . , 120(n) is switched to the IO-Link mode, the IO-Link logic 122 handles IO-Link protocol communication, working in conjunction with the DIO Control 123 to configure the four sets of pins 128a, . . . , 128d as four sets of IO-Link pins, each including a power supply pin L+, a communication/qualified input pin C/Qi, a communication/qualified output pin C/Qo, and an additional input/output pin I/Q. Thus, for example, in IO-Link mode:
set of pins 128a as configured by the DIO Control 123 includes pin L+(1), pin C/Qi(1), pin C/Qo(1), and pin I/Q(1);
set of pins 128b as configured by the DIO Control 123 includes pin L+(2), pin C/Qi(2), pin C/Qo(2), and pin I/Q(2);
set of pins 128c as configured by the DIO Control 123 includes pin L+(3), pin C/Qi(3), pin C/Qo(3), and pin I/Q(3); and
set of pins 128d as configured by the DIO Control 123 includes pin L+(4), pin C/Qi(4), pin C/Qo(4), and pin I/Q(4).
When a device 120(1), . . . , 120(n) is switched to the DIO mode, the DIO Control 123 handles DIO communication, configuring the four sets of pins 128a, . . . , 128d as eight sets of digital input channels and eight sets of digital output channels. This configuration can be done in two ways, namely having all eight digital output channels acting as high-side outputs, or four high-side outputs and four low-side outputs.

If the four sets of pins 128a, . . . , 128d are considered as four sets of IO-Link pins (but configured as DIO pins), each including an L+ pin, a C/Qi pin, a C/Qo pin, and an I/Q pin, then for the eight digital input channels, the C/Qi pins would serve as the digital inputs for channels one through four and the I/Q pins would serve as the digital inputs for channels five through eight, and for the eight digital output channels, the L+ pins would serve as the digital outputs for channels one through four and the C/Qo pins would serve as the digital outputs for channels five through eight. Here, the configuration of the digital output channels can be using all eight channels as high-side outputs (using the L+ and C/Qo pins), or four high-side outputs (using the L+ pins) and four low-side outputs (using the C/Qo pins). This flexibility allows for adaptation to various industrial control scenarios. Thus, for example, in DIO mode:
set of pins 128a as configured by the DIO Control 123 includes pin DO(1), pin DI(1), pin DO(2), and pin DI(2);
set of pins 128b as configured by the DIO Control 123 includes pin DO(3), pin DI(3), pin DO(4), and pin DI(4);
set of pins 128c as configured by the DIO Control 123 includes pin DO(5), pin DI(5), pin DO(6), and pin DI(6); and
set of pins 128d as configured by the DIO Control 123 includes pin DO(7), pin DI(7), pin DO(8), and pin DI(8).

The output drivers 126 and input filters 127 help ensure that the electrical characteristics of the signals output thereby and input thereto meet the requirements of both IO-Link and DIO protocols (depending on mode of operation), including voltage levels and current capabilities. In DIO mode for example, the output driver 126 can handle currents up to 500 mA per channel, at frequencies up to and exceeding 250 kHz, making it suitable for directly driving various industrial loads and compliant with the IEC61131-2 standard for programmable controllers, providing for compatibility with a wide range of industrial automation systems.

The SPI interface 121 includes SDI(Serial Data In), SDO(Serial Data Out), CS (Chip Select), and CLK (Clock) pins. The devices 120(1), . . . , 120(n) are connected with one another in a daisy chain arrangement, with the MOSI pin of the MCU 110 being connected to the SDI pin of the SPI interface 121 of the device 120(1), the CS pin of the MCU 110 being connected to the CS pins of the SPI interface 121 of the device 120(1), . . . , 120(n), and the CLK pin of the MCU 110 being connected to the CLK pins of the SPI interfaces 121 of the device 120(1), . . . , 120(n). Due to the daisy chain arrangement, the SDO pin of the SPI interface 121 of the device 120(1) is connected to the SDI pin of the SPI interface of the next device in the chain, which in turn has its SDO pin connected to the SDI pin of the SPI interface of the next device in the chain, with the SDO pin of the SPI interface of the final device in the chain being connected to the MISO pin of the MCU 110.

The device 120(1) also includes a Monitor, Protection, and Fault Alarm block 131 connected between the SPI interface 121 and the digital logic block 129. This block 131 serves multiple critical functions to enhance the reliability and safety of the system. It continuously monitors the operating conditions of the device, including voltage levels, current draw, and temperature. The protection aspect of block 131 implements safeguards against potential hazards such as overcurrent, overvoltage, and overtemperature conditions, automatically initiating protective measures when necessary. Additionally, the fault alarm functionality allows the block 131 to detect and report various fault conditions to the MCU 110 via the SPI interface 121, enabling rapid response to any issues that may arise during operation.

The daisy-chain configuration of the devices 120(1), . . . , 120(n) offers several advantages. It allows for efficient use of the resource of the MCU 110, as a single set of SPI pins can control multiple devices. This configuration also enables easy scalability of the system; additional devices can be added to the chain without requiring extra pins on the MCU 110. The daisy-chain arrangement is particularly beneficial in applications such as remote I/O modules, where multiple I/O points may be distributed over a significant distance. Indeed, each device 120(1), . . . , 120(n) in the chain can be individually addressed and configured by the MCU 110 through the SPI interface. This allows for dynamic reconfiguration of the system, where some devices can be set to IO-Link mode while others operate in DIO mode, providing a highly flexible I/O solution for complex industrial automation scenarios.

The system 100 represents an advancement in industrial automation technology by integrating IO-Link master functionality and reconfigurable digital I/O capabilities into a single, versatile device. The system 100 design offers substantial benefits over traditional approaches that rely on separate ICs for IO-Link and digital I/O functions.

The advantages include reduced system complexity, lower component count, lower pin count, decreased costs, and enhanced flexibility. By consolidating multiple functions into one device and enabling easy scalability through daisy-chaining, the system 100 provides a powerful and adaptable tool for a wide spectrum of industrial applications.

Indeed, the system 100 is particularly valuable in IO-Link Master systems, where it can replace numerous single and dual-channel ICs, as well as in Digital I/O or Remote I/O modules and Hubs, where its reconfigurable nature accommodates varying I/O requirements. The combination of mode flexibility, scalability, and integrated functionality makes the system 100 particularly valuable for diverse industrial automation scenarios, ranging from basic machine control to sophisticated, distributed I/O systems. As a result, manufacturers gain access to a highly efficient and versatile tool that can significantly streamline their automation processes and adapt to evolving industrial needs.

Finally, it is evident that modifications and variations can be made to what has been described and illustrated herein without departing from the scope of this disclosure.

Although this disclosure has been described with a limited number of embodiments, those skilled in the art, having the benefit of this disclosure, can envision other embodiments that do not deviate from the disclosed scope. Furthermore, skilled persons can envision embodiments that represent various combinations of the embodiments disclosed herein made in various ways.

1. A system, comprising:
a microcontroller unit (MCU); and
a plurality of reconfigurable devices connected to the MCU in a daisy chain arrangement via a Serial Peripheral Interface (SPI) protocol, each reconfigurable device comprising:
digital Input/Output (DIO) control circuitry configured for operating in both a Digital Input/Output (DIO) mode and an IO-Link mode;
input/output link (IO-Link) logic circuitry configured for providing data to, and reading data from, the DIO control circuitry when the DIO control circuitry is operating in the IO-Link mode;
digital logic for switching the DIO control circuitry between the DIO mode and the IO-Link mode;
output drivers connected between outputs of the DIO control circuitry and respective output pins of a plurality of pin sets;
input filters connected between inputs of the DIO control circuitry and respective inputs pins of the plurality of pin sets; and
an SPI interface for communication with the MCU and other reconfigurable devices in the daisy chain arrangement, wherein the digital logic facilitates communication between the SPI interface and the DIO control circuitry, and wherein the digital logic facilitates communication between the SPI interface and the IO-Link logic circuitry.

2. The system of claim 1, wherein each of the plurality of pin sets comprises:
a power supply pin (L+);
a communication/qualified input pin (C/Qi);
a communication/qualified output pin (C/Qo); and
an additional input/output pin (I/Q).

3. The system of claim 2, wherein in the IO-Link mode, each pin set is configured as an IO-Link channel.

4. The system of claim 2, wherein in the DIO mode:
the C/Qi pins and I/Q pins of the plurality of pin sets are configured as digital input channels; and
the L+ pins and C/Qo pins of the plurality of pin sets are configured as digital output channels.

5. The system of claim 4, wherein the digital output channels are configurable as either all high-side outputs.

6. The system of claim 4, wherein the digital output channels are configurable as a combination of high-side and low-side outputs.

7. The system of claim 1, wherein the SPI interface of each reconfigurable device comprises:
a Serial Data In (SDI) pin;
a Serial Data Out (SDO) pin;
a Chip Select (CS) pin; and
a Clock (CLK) pin.

8. The system of claim 7, wherein:
a MOSI pin of the MCU is connected to the SDI pin of a first reconfigurable device in the daisy chain arrangement;
a CS pin of the MCU is connected to the CS pins of all reconfigurable devices;
a CLK pin of the MCU is connected to the CLK pins of all reconfigurable devices; and
the SDO pin of each reconfigurable device is connected to the SDI pin of the next reconfigurable device in the daisy chain arrangement, with the SDO pin of a last reconfigurable device connected to a MISO pin of the MCU.

9. The system of claim 1, wherein each reconfigurable device in the daisy chain arrangement is individually addressable and configurable by the MCU through the SPI interface.

10. A method of operating a system comprising a microcontroller unit (MCU) and a plurality of reconfigurable devices connected to the MCU in a daisy chain arrangement via a Serial Peripheral Interface (SPI) protocol, the method comprising:
configuring each reconfigurable device to operate in either a Digital Input/Output (DIO) mode or an IO-Link mode;
for each reconfigurable device operating in the IO-Link mode: providing data to, and reading data from, DIO control circuitry via IO-Link logic circuitry;
for each reconfigurable device operating in the DIO mode: controlling digital inputs and outputs via the DIO control circuitry;
switching the DIO control circuitry between the DIO mode and the IO-Link mode using digital logic;
driving outputs from the DIO control circuitry to respective output pins of a plurality of pin sets via output drivers;
filtering inputs to the DIO control circuitry from respective input pins of the plurality of pin sets via input filters; and
facilitating communication between an SPI interface and the DIO control circuitry, and between the SPI interface and the IO-Link logic circuitry, via the digital logic.

11. The method of claim 10, further comprising: configuring each of the plurality of pin sets to comprise: a power supply pin (L+); a communication/qualified input pin (C/Qi); a communication/qualified output pin (C/Qo); and an additional input/output pin (I/Q).

12. The method of claim 11, further comprising: in the IO-Link mode, configuring each pin set as an IO-Link channel.

13. The method of claim 11, further comprising: in the DIO mode: configuring the C/Qi pins and I/Q pins of the plurality of pin sets as digital input channels; and configuring the L+ pins and C/Qo pins of the plurality of pin sets as digital output channels.

14. The method of claim 13, further comprising: configuring the digital output channels as either all high-side outputs or as a combination of high-side and low-side outputs.

15. The method of claim 10, further comprising: configuring the SPI interface of each reconfigurable device to comprise: a Serial Data In (SDI) pin; a Serial Data Out (SDO) pin; a Chip Select (CS) pin; and a Clock (CLK) pin.

16. The method of claim 15, further comprising: connecting a MOSI pin of the MCU to the SDI pin of a first reconfigurable device in the daisy chain arrangement; connecting a CS pin of the MCU to the CS pins of all reconfigurable devices; connecting a CLK pin of the MCU to the CLK pins of all reconfigurable devices; and connecting the SDO pin of each reconfigurable device to the SDI pin of the next reconfigurable device in the daisy chain arrangement, with the SDO pin of a last reconfigurable device connected to a MISO pin of the MCU.

17. The method of claim 10, further comprising: individually addressing and configuring each reconfigurable device in the daisy chain arrangement by the MCU through the SPI interface.
